(19) United States
(12) Patent Application Publication
(10) Pub. No.: US 2025/0034668 A1
(43) Pub. Date: Jan. 30, 2025

(54) Steelmaking method and associated network of plants

(71) Applicant: ArcelorMittal, Luxembourg (LU)

(72) Inventors: Manfred VAN VLIERBERGHE, Gent (BE); Jean-Luc Didier REBOUL, Bouc Bel Air (FR); Dominique SERT, Montoy Flanville (FR); Wim VAN DER STRICHT, Gent (BE)

(21) Appl. No.: 18/716,423

(22) PCT Filed: Dec. 7, 2022
(86) PCT No.: PCT/IB2022/061862

§ 371 Date: Jun. 4, 2024

(30) Foreign Application Priority Data
Dec. 16, 2021 (WO) PCT/IB2021/061837

(51) Int. Cl. C21C 5/52; C21B 5/06; C21B 13/00; C21C 5/40

(52) U.S. Cl. CPC C21C 5/527; C21B 5/06; C21B 13/0073; C21C 5/40; C21B 2100/80; C21C 2100/04

(57) ABSTRACT

A Steel manufacturing method including the step of producing direct reduced iron (12) and a reduction top gas (13) in a direct reduction plant (1) using a reducing gas (11), the reduction top (13) being at least partly (13A) recycled as reducing gas (11), producing hot metal and a blast furnace top gas (21) in a blast furnace (2), wherein from 200 Nm3 to 700 Nm3 of hydrogen (20) per ton of hot metal to be produced are injected and the blast furnace top gas (21A) being at least partly sent to a biochemical plant (4) to produce hydrocarbons and producing molten metal and electric furnace gas in an electric furnace (3) using at least a part of the produced direct reduced iron (12).

The invention is related to a steelmaking method and to the associated network of plants.

### BACKGROUND

Steel can be currently produced through two main manufacturing routes. Nowadays, the most commonly used production route named the “BF-BOF route” consists in producing hot metal in a blast furnace, by use of a reducing agent, mainly coke, to reduce iron oxides and then transform hot metal into steel into a converter process or Basic Oxygen furnace (BOF). This route, both in the production of coke from coal in a coking plant and in the production of the hot metal, releases significant quantities of CO2.

The second main route involves so-called “direct reduction methods”. Among them are methods according to the brands MIDREX, FINMET, ENERGIRON/HYL, COREX, FINEX etc., in which sponge iron is produced in the form of HDRI (hot direct reduced iron), CDRI (cold direct reduced iron), or HBI (hot briquetted iron) from the direct reduction of iron oxide carriers. Sponge iron in the form of HDRI, CDRI, and HBI usually undergo further processing in electric furnaces.

### SUMMARY OF THE INVENTION

Reducing CO2 emissions to meet climate targets is challenging as the currently dominating form of steelmaking, the blast furnace-basic oxygen furnace (BF-BOF) route is dependent on coal as a reductant and fuel. There are two options for reducing CO2 emissions from steelmaking: to keep the BF-BOF route and implement carbon capture use and/or storage of CO2 (CCS or CCU) technology, or to seek new low-emissions processes.

A first step towards CO2 emissions reductions may be then to switch from a BF-BOF route to a DRI route. As this represents big changes, both in terms of equipment, but also in terms of process, all blast furnaces will not be replaced at once by direct reduction equipment. Moreover, this switch from one route to the other represents both technical and economic challenges which have first to be solved before a carbon-neutral production route is made available. There would thus be some plants where the different equipment will coexist.

Moreover, although an ever-increasing part of the steel demand will be covered with scrap/DRI-based production, the need for steel production will remain high and the classical BF technology is still expected to be the major production route for many decades to come.

There is thus a need for a method allowing to produce steel according to an hybrid BF/DRI route with a reduced CO2 footprint.

The present invention provides a method wherein direct reduced iron and a reduction top gas are produced in a direct reduction plant using a reducing gas, the reduction top gas being at least partly recycled as reducing gas, hot metal and a blast furnace top gas are produced in a blast furnace wherein from 200 Nm3 to 700 Nm3 of hydrogen per ton of hot metal to be produced are injected and the blast furnace top gas is at least partly sent to a biochemical plant to produce hydrocarbons and molten metal and electric furnace gas are produced in an electric furnace using at least a part of the produced direct reduced iron.

The method of the invention may also comprise the following optional characteristics considered separately or according to all possible technical combinations:
hydrogen is injected in the blast furnace at a temperature comprised between 75° and 1100° C.,
hydrogen is injected into the shaft of the blast furnace,
the or one of the hydrogen sources of the hydrogen injected into the blast furnace is a waste gas from chemical industry,
the method further comprises a step of producing coke and a coke oven gas in a coke plant, said coke being at least partly charged into the blast furnace for the hot metal production step, said coke oven gas being the or one of the hydrogen sources of hydrogen injected into the blast furnace,
the reducing gas for the direct reduced iron production step comprises coke oven gas,
the reduction top gas is the or one of the hydrogen sources of the hydrogen injected into the blast furnace,
the reduction top gas is at least partly injected as reductant into the shaft of the blast furnace,
the reduction top gas is at least partly sent to the biochemical plant to produce hydrocarbons,
hydrogen is added to the blast furnace top gas before its use in the biochemical plant,
the reducing gas for the direct reduced iron production step comprises at least 70% v of hydrogen,
said hydrogen is green hydrogen,
the molten metal produced in the electric furnace is transformed in liquid steel in a converter,
green hydrogen is injected into the blast furnace,
the blast furnace top gas is recycled as reductant in the blast furnace,
the method further comprises a step of recovering all gases emitted during steel production in a gas hub and redirect them for recycling within the steel production process,
all the steps are supplied with renewable energy,
the hot metal is used in the electric furnace to produce molten metal,
scrap is used in the electric furnace to produce molten metal.

The invention is also related to a network of plants comprising a direct reduction plant producing direct reduced iron and a reduction top gas using a reducing gas, a blast furnace producing hot metal and a blast furnace top gas provided with means to inject between 200 Nm3 and 700 Nm3 of hydrogen per ton of hot metal to be produced, and an electric furnace producing molten metal and electric furnace gas using at least a part of the produced direct reduced iron, a biochemical plant able to produce hydrocarbons, a gas distribution system designed so as to allow the reduction top gas to be at least partly recycled as reducing gas within the direct reduction plant, hydrogen to be supplied to the means to inject hydrogen of the blast furnace and, the blast furnace top gas to be at least partly sent to the biochemical plant for hydrocarbons production.

### BRIEF DESCRIPTION OF THE DRAWINGS

Other characteristics and advantages of the invention will emerge clearly from the description of it that is given below by way of illustration, and which is in no way restrictive, with reference to the appended FIGURES in which:

FIG. 1 illustrates a network of plants allowing to perform a method according to the invention

### DETAILED DESCRIPTION

Elements in the figures are illustration and may not have been drawn to scale.

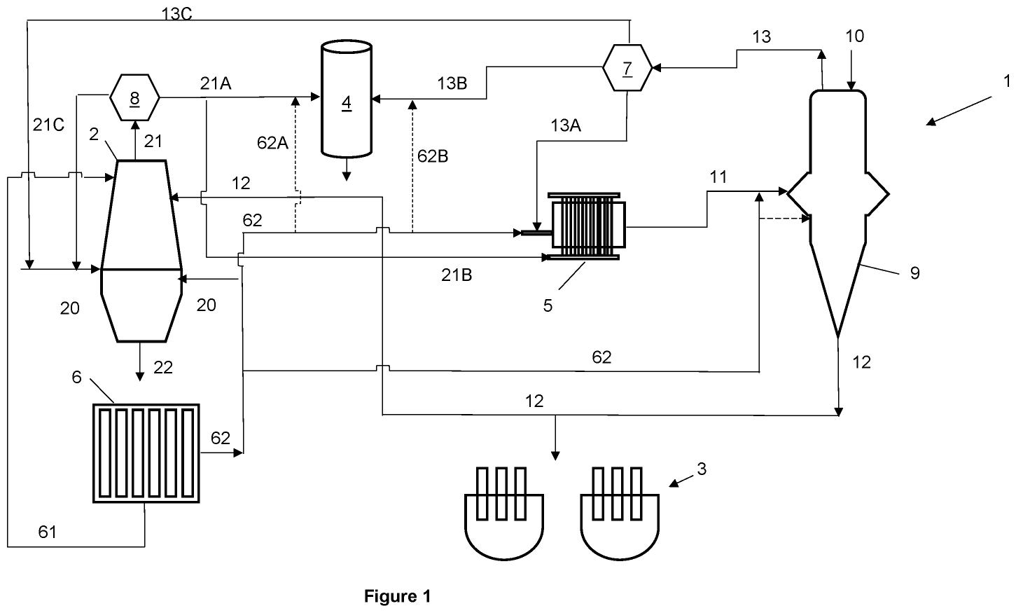

FIG. 1 illustrates a network of plants comprising a direct reduction plant 1, a blast furnace 2, an electric furnace 3 and a biochemical plant 4.

The direct reduction plant 1 comprises a shaft furnace 9 and a gas preparation device 5. In working mode, iron oxide ores and pellets 10 containing around 30% by weight of oxygen are charged to the top of the shaft furnace 9 and are allowed to descend, by gravity, through a reducing gas 11. This reducing gas 11 prepared by the gas preparation device 5 is injected into the furnace 9 so as to flow counter-current from the charged oxidised iron. Oxygen contained in ores and pellets is removed in stepwise reduction of iron oxides in counter-current reaction between gases and oxide. Oxidant content of gas is increasing while gas is moving to the top of the furnace. Reduced iron, also called DRI product 12 exits at the bottom of the furnace 9 while a reduction top gas 13 exits at the top of the furnace 9. This reduction top gas 13 is captured and treated in a first gas treatment unit 7. Composition of this reduction top gas 13 vary according to the composition of the reducing gas 11 injected into the shaft furnace 9.

The blast furnace 2 is a gas-liquid-solid counter-current chemical reactor whose main objective is to produce hot metal 22, which is then converted to steel by reducing its carbon content. The blast furnace 2 is conventionally supplied with solid materials, mainly sinter, pellets, iron ore and carbonaceous material, generally coke, charged into its upper part, called throat of the blast furnace. The liquids consisting of hot metal and slag are tapped from the crucible in the bottom of the blast furnace 2. The iron-containing burden (sinter, pellets and iron ore) is converted to hot metal 22 conventionally by reducing the iron oxides with a reducing gas (containing CO, H2 and N2 in particular), which is formed by partial combustion of the carbonaceous material thanks to a hot blast 20 injected by tuyeres located in the lower part of the blast furnace, usually at a temperature between 100° and 1300° C. Injections of reductants may also be performed in the upper part of the blast furnace, above the tuyeres, this is called shaft injection.

The resulting gas exhaust at the top of the blast furnace and is called blast furnace top gas 21. This blast furnace top gas 21 is captured and treated in a second gas treatment unit 8. Composition of this blast furnace top gas 21 varies according to the composition of the reductants injected into the blast furnace 2.

The electric furnace 3 may be of different kinds. It may notably be an electric arc furnace (EAF), a smelting furnace, a submerged arc furnace (SAF) or an open slag bath furnace (OSBF). The aim of this furnace is to melt the charged material, among this charge material being at least a part of the direct reduced iron 12 produced by the direct reduction plant 1. This direct reduced iron 12 may be charged hot directly at the exit of the direct reduction plant 1 or cold. The electric furnace 3 may also be charged with hot metal 22 produced by a blast furnace and/or scrap. According to the technology and charged material used, the produced molten metal may be either sent to a converter to reduce carbon content and/or to secondary metallurgy to refine steel and bring it to the appropriate composition for further processing steps.

The biochemical plant 4 is a plant allowing transformation of the blast furnace top gas 21A into alcohol using biology. It may be a fermentation or electro-fermentation plant using microbes, bacteria or algae to turn CO or CO2 and H2 contents of the BFG into hydrocarbons, for example ethanol.

In the embodiment of FIG. 1 the plant further comprises a coke plant 6, which is optional to perform the method according to the invention. Coke 61 is manufactured by heating coal to very high temperatures, usually around 1000° C., in so-called “coke ovens” which are thermally insulated chambers. During the cooking of coal, organic substances in the coal blend vaporize or decompose, producing a coke oven gas (COG) 62 and coal-tar (a thick dark liquid used in industry and medicine).

In a preferred embodiment all those plants are operated with renewable energy which is defined as energy that is collected from renewable resources, which are naturally replenished on a human timescale, including sources like sunlight, wind, rain, tides, waves, and geothermal heat. In some embodiments, the use of electricity coming from nuclear sources can be used as it is not emitting CO2 to be produced.

In the method according to the invention at least a part 13A of the direct reduction top gas is recycled as reducing gas 11, between 200 and 700 Nm3 of hydrogen per ton of hot metal to be produced are injected into the blast furnace 2, and at least a part 21A of the blast furnace top gas is at sent to the biochemical plant 4.

Nm3 is a unit of measurement of the quantity of gas which corresponds to the content of a volume of one cubic metre, for a gas under normal conditions of temperature and pressure (0° C. and 1 atm).

Combination of those different features allow to reduce the overall carbon footprint of the process while using both DRI and blast furnaces processes.

At least a part 13 A of the direct reduction top gas 13 is recycled as reducing gas 11. In a preferred embodiment, the direct reduction top gas 13 is captured and treated in a first gas treatment unit 7 which may, among other devices, comprise a water removal device and a CO2 separation unit. The treated gas may be split into at least two streams, the first one 13A being recycled within the direct reduction plant as reducing gas 11 and the second one 13B being sent to the biochemical plant 4 to be turned into hydrocarbons. In another embodiment this second stream 13C may also be sent to the blast furnace 2 to be used in the hot blast 20 or injected into the blast furnace shaft as a reductant after heating. The direct reduction top gas 13 may also be split into three or more streams and used as described in previous embodiments.

From 200 to 700 Nm3 of hydrogen per ton of hot metal to be produced are injected as reducing gas into the blast furnace 2. This hydrogen is preferentially injected at a temperature comprised between 75° and 1100° C., preferentially between 90° and 1000° C. It may be injected in the shaft of the blast furnace 2 and/or at the tuyere level as part of the hot blast.

Introduction of this hydrogen allows a partial reduction of the wustite of the ferrous burden at an earlier stage into the furnace and hence, to perform in-situ metallization of the iron charge inside the furnace. It will thus lower the required input of fossil carbon, in the form of powder coal and cokes and thus recue CO2 emissions of the process and carbon footprint.

Below 200 Nm3/thm, there might be some issues concerning the homogeneous distribution of the reducing gas over the periphery of the blast furnace, leading to disturbances induced by a heterogeneous metallization of the ferrous burden. On the other hand, injecting 700 Nm3/thm of hydrogen is sufficient to convert all the iron oxides of the ferrous burden into metallic iron at the injection level. Injecting hydrogen in excess of 700 Nm3/thm would then bring no further advantage as this hydrogen will not react with iron oxides, it would just contribute to the heating of the blast furnace top gas.

This hydrogen may come from several sources. It may be brought by or extracted from the coke oven gas 61. It may also come from the direct reduction top gas 13C and/or from the blast furnace top gas 21C, according to the composition of said gases which depend respectively on the compositions of the reducing gas 11 and of the reductants 20 injected in the blast furnace 2.

In another embodiment the hydrogen is provided by a waste gas coming from a chemical plant, such as a plant for hydrocarbons production. This chemical plant may be independent of the steelmaking plant. This allows to create a synergy with existing industrial environment of the steelmaking plant allowing to reduce even more globally the carbon footprint. Waste gas are gases resulting from the chemicals production that are not used inside the chemical plant and might for example be directed to a Flare for the purpose of disposing of the gas.

In a further embodiment the hydrogen is green hydrogen. Green hydrogen is a hydrogen-produced fuel obtained from electrolysis of water with electricity generated by low-carbon power sources which includes notably electricity from renewable sources as previously defined.

All those different sources of hydrogen previously described may be mixed with one another to get the necessary reducing conditions within the blast furnace.

Use from 200 to 700, preferably from 200 to 670 Nm3, of hydrogen per ton of hot metal in the BF will lower the required input of fossil carbon, in the form of powder coal and cokes, and thus reduce CO2 emissions of the process and carbon footprint.

In a preferred embodiment the reducing gas 11 used in the direct reduction plant 1 also comprises hydrogen, at least 70% in volume. This hydrogen may come from all the previously mentioned hydrogen sources but is preferentially green hydrogen.

In the method according to the invention the blast furnace top gas 21 or BFG is at least partly sent to the biochemical plant 4 to produce hydrocarbons. Said blast furnace top gas 21 is recovered and treated in the second gas treatment unit 8. This second gas treatment unit 8 may, among other devices, comprise a dust filter unit, a water removal device and a CO2 separation unit such as a Pressure Swing Adsorption device. BFG may be split in two streams 21A, 21B, the first stream 21A being sent to the biochemical plant 4 while the other stream 21B is sent to the direct reduction plant 1. There, it may be used to heat the reducing gas 11 in the gas preparation device 5, either by direct thermal exchange or by use as fuel in burners. In another embodiment this second stream 21C is re-injected into the blast furnace at the tuyere level. The BFG may also be split into three streams used as described in previous embodiments.

In a preferred embodiment hydrogen coming from one the previously described sources, such as the coke oven gas 62A, 62B can also be added to the blast furnace top gas 21A, and optionally to the direct reduction top gas 13B to increase their hydrogen content before they are sent to the biochemical plant 4. This allows to optimize the production of hydrocarbons in the biochemical plant 4.

In a preferred embodiment the steel plant comprises a gas hub (not represented) which is able to recover all the gases emitted in the steel production process but also available external gases and redirect them for recycling within the steel production process according to each gas composition and each process needs both in terms of reactants and energy. A hub is defined as a trading point to allow interchangeability between several streams. The gas-hub is a conversion, conditioning and storage facility for multiple energy carriers such as internal and external waste and tail gases, recovered or green hydrogen etc., Presence of such an interconnected entry/exit system for gas feeds allows an improved global management of the different gases and energy needs of the system and thus a reduction of the carbon footprint.

In a preferred embodiment all the gases emitted in the steelmaking plant may be treated in a gas treatment unit to produce hydrogen, said hydrogen being then re-used within the steel plant for example as reductant in the blast furnace or the direct reduction furnace.

With the method according to the invention it is possible to produce steel using a hybrid BF/DRI route with reduced carbon footprint. This method moreover allows to make the transition between the most commonly used BF/BOF route towards a DRI-based carbon neutral route in a sustainable way.

In the embodiment of FIG. 1 all plants are represented together but they may be located on different production sites and the different gases and material transported from plant to another by appropriate means.

All the different embodiment described may be used in combination with one another when technically possible.

What is claimed is:

1-20. (canceled)

21: A steel manufacturing method comprising the steps of:
a. producing direct reduced iron and a reduction top gas in a direct reduction plant using a reducing gas, the reduction top gas being at least partly recycled as the reducing gas;
b. producing hot metal and a blast furnace top gas in a blast furnace, wherein from 200 Nm3 to 700 Nm3 of hydrogen per ton of hot metal to be produced are injected and the blast furnace top gas being at least partly sent to a biochemical plant to produce hydrocarbons; and
c. producing molten metal and electric furnace gas in an electric furnace using at least a part of the produced direct reduced iron.

22: The method as recited in claim 21 wherein the hydrogen is injected in the blast furnace at a temperature comprised between 75° and 1100° C.

23: The method as recited in claim 21 wherein the hydrogen is injected into a shaft of the blast furnace.

24: The method as recited in claim 21 wherein at least one hydrogen source of the hydrogen injected into the blast furnace is a waste gas from chemical industry.

25: The method as recited in claim 21 further comprising a step of producing coke and a coke oven gas in a coke plant, the coke being at least partly charged into the blast furnace for the hot metal production step, the coke oven gas being a hydrogen source of the hydrogen injected into the blast furnace.

26: The method as recited in claim 25 wherein the reducing gas for the direct reduced iron production step includes the coke oven gas.

27: The method as recited in claim 21 wherein the reduction top gas is hydrogen sources of the hydrogen injected into the blast furnace.

28: The method as recited in claim 21 wherein the reduction top gas is at least partly injected as reductant into a shaft of the blast furnace.

29: The method as recited in claim 21 wherein the reduction top gas is at least partly sent to the biochemical plant to produce hydrocarbons.

30: The method as recited in claim 21 wherein the hydrogen is added to the blast furnace top gas before use in the biochemical plant.

31: The method as recited in claim 21 wherein the reducing gas for the direct reduced iron production step including at least 70% v of hydrogen.

32: The method as recited in claim 31 wherein said hydrogen is green hydrogen.

33: The method as recited in claim 21 wherein the molten metal produced in the electric furnace is transformed in liquid steel in a converter.

34: The method as recited in claim 21 wherein green hydrogen is injected into the blast furnace.

35: The method as recited in claim 21 wherein the blast furnace top gas is recycled as reductant in the blast furnace.

36: The method as recited in claim 21 further comprising a step of recovering all gases emitted during steel production in a gas hub and redirecting the recovered gases for recycling within the steel production process.

37: The method as recited in claim 21 wherein all the steps are supplied with renewable energy.

38: The method as recited in claim 21 wherein the hot metal is used in the electric furnace to produce molten metal.

39: The method as recited in claim 21 wherein scrap is used in the electric furnace to produce molten metal.

40: A network of plants comprising:
a direct reduction plant producing direct reduced iron and a reduction top gas using a reducing gas;
a blast furnace producing hot metal and a blast furnace top gas provided with at least one injection location for receiving between 200 Nm3 and 700 Nm3 of hydrogen per ton of hot metal to be produced;
an electric furnace producing molten metal and electric furnace gas using at least a part of the produced direct reduced iron;
a biochemical plant able to produce hydrocarbons; and
a gas distribution system designed so as to allow:
i. the reduction top gas to be at least partly recycled as reducing gas within the direct reduction plant,
ii. hydrogen to be supplied to the at least one injection location of the blast furnace,
the blast furnace top gas to be at least partly sent to the biochemical plant for hydrocarbon production.
